(19) United States
(12) Patent Application Publication
(10) Pub. No.: US 2016/0292812 A1
(43) Pub. Date: Oct. 6, 2016

(54) HYBRID 2D/3D GRAPHICS RENDERING

(71) Applicant: QUALCOMM Incorporated, San Diego, CA (US)

(72) Inventors: Chehui Wu, San Diego, CA (US); Guofang Jiao, San Diego, CA (US); Jian Liang, San Diego, CA (US); Minjie Huang, San Diego, CA (US)

(21) Appl. No.: 14/865,776

(22) Filed: Sep. 25, 2015

Related U.S. Application Data
(60) Provisional application No. 62/141,095, filed on Mar. 31, 2015.

(51) Int. Cl. G06T 1/20; G06T 3/40; G06T 15/50; G06T 1/60; G06T 15/00; G06T 11/00

(52) U.S. Cl. CPC G06T 1/20; G06T 15/005; G06T 11/001; G06T 15/503; G06T 1/60; G06T 3/40

(57) ABSTRACT

A graphics processing unit (GPU) may perform three-dimensional (3D) graphics processing in accordance with a 3D graphics pipeline using a first plurality of graphics processing hardware units of the GPU. The GPU may further perform a two-dimensional (2D) graphics operation using a second plurality of graphics processing hardware units of the GPU not used in performing the 3D graphics processing and one or more graphics processing hardware units of the first plurality of graphics processing hardware units of the GPU.

This application claims the benefit of U.S. Provisional Application No. 62/141,095, filed Mar. 31, 2015, the entire content of which is incorporated by reference herein in its entirety.

### TECHNICAL FIELD

The disclosure relates to graphics processing of two-dimensional (2D) and three-dimensional (3D) images.

### BACKGROUND

Graphics processing units (GPUs) are specialized hardware units used to render 2D as well as 3D images. A software application may invoke a mixture of 2D graphics operations as well as 3D graphics operations. As such, a GPU may need to include separate graphics hardware for processing and rendering 2D graphics and 3D graphics.

### SUMMARY

In general, aspects of the disclosure are directed to a GPU that is configured to perform 3D graphics processing in accordance with a 3D graphics pipeline as well as to perform 2D graphics processing in accordance with a 2D graphics pipeline. The GPU may include a set of 3D hardware units which may be used to perform graphics processing in accordance with the 3D graphics pipeline. The set of 3D hardware units may include shader processors, texture processors, caches, and the like. The GPU may utilize a subset of those 3D hardware units in conjunction with a set of dedicated 2D graphics hardware units to also perform 2D graphics processing in accordance with a 2D graphics pipeline. The set of 2D hardware units may include circuitry for performing direct memory access (DMA) transfers, hardware units for controlling reads and writes to memory, and the like. By utilizing the set of dedicated 2D graphics hardware units together with a subset of the 3D hardware units, the GPU may increase performance of 2D graphics processing and may further decrease power consumption during the performance 2D graphics processing while minimizing the physical area of the GPU that is dedicated to specialized 2D hardware units.

In one aspect, the disclosure is directed to a method for graphics processing. The method may include performing, by a graphics processing unit (GPU), three-dimensional (3D) graphics processing in accordance with a 3D graphics pipeline using a first plurality of graphics processing hardware units of the GPU. The method may further include performing, by the GPU, a two-dimensional (2D) graphics operation using a second plurality of graphics processing hardware units of the GPU not used in performing the 3D graphics processing and one or more graphics processing hardware units of the first plurality of graphics processing modules of the GPU.

In another aspect, the disclosure is directed to a device. The device may include a memory. The device may further include a graphics processing unit (GPU) including a first plurality of graphics processing hardware units and a second plurality of graphics processing hardware units, wherein the GPU is configured to perform three-dimensional (3D) graphics processing in accordance with a 3D graphics pipeline using the first plurality of graphics processing hardware units of the GPU, and wherein the GPU is further configured to perform a two-dimensional (2D) graphics operation using the second plurality of graphics processing hardware units of the GPU and one or more graphics processing hardware units of the first plurality of graphics processing hardware units.

In another aspect, the disclosure is directed to an apparatus for graphics processing. The apparatus may include means for performing three-dimensional (3D) graphics processing in accordance with a 3D graphics pipeline using a first plurality of graphics processing hardware units. The apparatus may further include means for performing a two-dimensional (2D) graphics operation using a second plurality of graphics processing hardware units not used in performing the 3D graphics processing and one or more graphics processing hardware units of the first plurality of graphics processing hardware units.

In another aspect, the disclosure is directed to a graphics processing unit (GPU). The GPU may include a first plurality of graphics processing hardware units and a second plurality of graphics processing hardware units, wherein the GPU is configured to perform three-dimensional (3D) graphics processing in accordance with a 3D graphics pipeline using the first plurality of graphics processing hardware units of the GPU, and wherein the GPU is further configured to perform a two-dimensional (2D) graphics operation using the second plurality of graphics processing hardware units of the GPU and one or more graphics processing hardware units of the first plurality of graphics processing hardware units.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be configured to implement one or more aspects of this disclosure.

FIG. 2 is a block diagram illustrating example implementations of the example processor, the example GPU, and the example system memory of FIG. 1.

FIGS. 3A-3D are block diagrams illustrating operating modes of the GPU of FIG. 2 in further detail.

FIG. 4 is a flow chart illustrating an example operation of a GPU configured in accordance with the examples of the disclosure.

### DETAILED DESCRIPTION

In general, aspects of the disclosure are directed to a processor (e.g., a GPU) that is configured to perform 3D graphics processing in accordance with a 3D graphics pipeline as well as to perform 2D graphics processing in accordance with a 2D graphics pipeline. The GPU may perform the 2D graphics processing using a portion of the hardware modules used to perform the 3D graphics processing together with hardware modules that are dedicated to performing the 2D graphics processing.

3D graphics processing may include processing 3D representations of geometric data to generate 2D images. For example, a GPU may process a 3D image that is represented by primitives, such as triangles, lines, points, and the like, through a 3D graphics pipeline, in which the GPU may process the primitives representing the 3D image via a sequence of steps to render a 2D representation of the 3D image. 2D graphics processing may include performing one or more 2D graphics operations, such as drawing rendering 2D geometric shapes such as lines, rectangles, or polygons, copying a block of pixels from one bitmap to another in a process known as bit block transfers (bitBLTs), moving blocks of pixels between memory (e.g., to and/or from graphics memory and system memory), scaling operations for bit blocks, blending operations for bit blocks, other operations on blocks of pixels of bitmaps, clear operations that writes a default value to a block of pixels, and the like.

A GPU may include a set of hardware modules for performing 3D graphics processing as well as a separate set of hardware modules for performing 2D graphics operations. For example, the GPU may include hardware modules such as shader processors, texture processors, and the like that are solely used to perform 3D graphics processing according to a 3D graphics pipeline. The GPU may also include hardware modules such as a dedicated 2D graphics engine that is solely used to perform 2D graphics processing. In this way, the GPU may optimize both 2D and 3D graphics processing by including dedicated hardware logic that is optimized for 2D graphics processing as well as a separate dedicated hardware logic that is optimized for 3D graphics processing.

However, including dedicated hardware logic that is optimized for 2D graphics processing as well as a separate dedicated hardware logic that is optimized for 3D graphics processing may require that the GPU dedicate a large amount of physical area to accommodate the separate dedicated hardware modules. In mobile devices, such as mobile phones, tablets, and the like, physical constraints of the mobile devices may make it impractical for the GPU to include dedicated hardware logic that is optimized for 2D graphics processing as well as a separate dedicated hardware logic that is optimized for 3D graphics processing. As such, in some examples, a GPU may include a set of hardware modules that may perform both 2D and 3D graphics processing. For example, the GPU may be configured to perform a 2D graphics pipeline using hardware modules that are also configured to perform a 3D graphics pipeline. By including only hardware modules that may perform both 2D and 3D graphics processing, such hardware modules may take up less physical area on a GPU.

Performing 2D graphics processing using hardware modules that are also configured to perform 3D graphics processing may, in some cases, potentially be relatively less efficient than performing such 2D graphics processing on a dedicated 2D graphics engine that is solely used to perform 2D graphics processing. Further, because 3D graphics processing may be more computationally complex than 2D graphics processing, hardware modules that are configured to perform 3D graphics processing may be more powerful and more complex than dedicated hardware modules configured to perform 2D graphics processing. As such, performing 2D graphics processing using hardware modules that are also configured to perform 3D graphics processing may also consume more power than performing such 2D graphics processing on dedicated hardware modules configured to perform 2D graphics processing.

In view of the situation described above, this disclosure describes devices and techniques for a GPU to more efficiently perform 2D graphics processing while minimizing both power consumption as well as the physical area of the GPU taken up by the various hardware units. In some examples of the disclosure, the GPU may perform 2D graphics processing using a combination of a portion of hardware modules configured to perform 3D graphics processing as well as dedicated hardware modules configured to perform 2D graphics processing. Depending on the 2D graphics operation to be performed, the GPU may use different portions of the hardware modules configured to perform 3D graphics processing to perform the 2D graphics operation. While performing a specific 2D graphics operation, the GPU may also clock gate or turn off portions of the hardware modules configured to perform 3D graphics processing that are not used to perform the specified 2D graphics operation.

In accordance with aspects of the present disclosure, the GPU may include a first plurality of graphics processing hardware units and a second plurality of graphics processing hardware units. The GPU may be configured to perform 3D graphics processing in accordance with a 3D graphics pipeline using the first plurality of graphics processing hardware units. The GPU may further be configured to perform a 2D graphics operation using the second plurality of graphics processing hardware units not used in performing the 3D graphics processing and one or more graphics processing hardware units of the first plurality of graphics processing hardware units of the GPU.

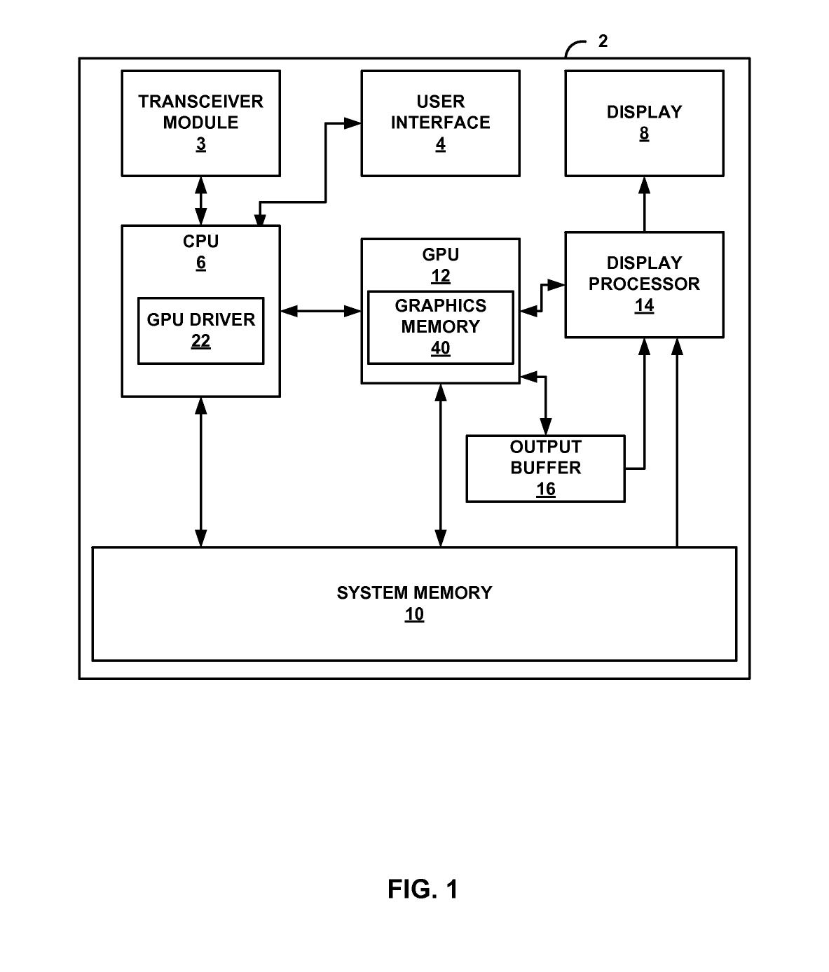

FIG. 1 is a block diagram illustrating an example computing device that may be configured to implement one or more aspects of this disclosure. As shown in FIG. 1, computing device 2 may be a computing device including but not limited to video devices, media players, set-top boxes, wireless handsets such as mobile telephones and so-called smartphones, personal digital assistants (PDAs), desktop computers, laptop computers, gaming consoles, video conferencing units, tablet computing devices, and the like. In the example of FIG. 1, computing device 2 may include central processing unit (CPU) 6, system memory 10, and GPU 12. Computing device 2 may also include display processor 14, transceiver module 3, user interface 4, and display 8. Transceiver module 3 and display processor 14 may both be part of the same integrated circuit (IC) as CPU 6 and/or GPU 12, may both be external to the IC or ICs that include CPU 6 and/or GPU 12, or may be formed in the IC that is external to the IC that includes CPU 6 and/or GPU 12.

Computing device 2 may include additional modules or units not shown in FIG. 1 for purposes of clarity. For example, computing device 2 may include a speaker and a microphone, neither of which are shown in FIG. 1, to effectuate telephonic communications in examples where computing device 2 is a mobile wireless telephone, or a speaker where computing device 2 is a media player. Computing device 2 may also include a video camera. Furthermore, the various modules and units shown in computing device 2 may not be necessary in every example of computing device 2. For example, user interface 4 and display 8 may be external to computing device 2 in examples where computing device 2 is a desktop computer or other device that is equipped to interface with an external user interface or display.

Examples of user interface 4 include, but are not limited to, a trackball, a mouse, a keyboard, and other types of input devices. User interface 4 may also be a touch screen and may be incorporated as a part of display 8. Transceiver module 3 may include circuitry to allow wireless or wired communication between computing device 2 and another device on a network. Transceiver module 3 may include modulators, demodulators, amplifiers and other such circuitry for wired or wireless communication.

CPU 6 may be a microprocessor, such as a central processing unit (CPU) configured to process instructions of a computer program for execution. CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spreadsheet application, a media player application, a video game application, a graphical user interface application or another program. Additionally, CPU 6 may execute GPU driver 22 for controlling the operation of GPU 12. The user may provide input to computing device 2 via one or more input devices (not shown) such as a keyboard, a mouse, a microphone, a touch pad or another input device that is coupled to computing device 2 via user interface 4.

The software applications that execute on CPU 6 may include one or more graphics rendering instructions that instruct GPU 12 to cause the rendering of graphics data to display 8. The instructions may include instructions to process 3D graphics as well as instructions to process 2D graphics. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, an Open Computing Language (OpenCL™) or any other public or proprietary standard GPU compute API. In order to process the graphics rendering instructions, CPU 6 may issue one or more graphics rendering commands to GPU 12 (e.g., through GPU driver 22) to cause GPU 12 to perform some or all of the rendering of the graphics data. In some examples, the graphics data to be rendered may include a list of graphics primitives, e.g., points, lines, triangles, quadrilaterals, triangle strips, etc.

GPU 12 may be configured to perform graphics operations to render one or more graphics primitives to display 8. Thus, when one of the software applications executing on CPU 6 requires graphics processing, CPU 6 may provide graphics commands and graphics data to GPU 12 for rendering to display 8. The graphics data may include, e.g., drawing commands, state information, primitive information, texture information, etc. GPU 12 may, in some instances, be built with a highly-parallel structure that provides more efficient processing of complex graphic-related operations than CPU 6. For example, GPU 12 may include a plurality of processing elements, such as shader units, that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 8 more quickly than drawing the scenes directly to display 8 using CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In some examples, GPU 12 may be on-chip with CPU 6, such as in a system on chip (SOC) GPU 12 may include one or more processors, such as one or more microprocessors, application specific integrated circuits (ASICs), field programmable gate arrays (FPGAs), digital signal processors (DSPs), or other equivalent integrated or discrete logic circuitry. GPU 12 may also include one or more processor cores, so that GPU 12 may be referred to as a multi-core processor.

In some examples, graphics memory 40 may be part of GPU 12. Thus, GPU 12 may read data from and write data to graphics memory 40 without using a bus. In other words, GPU 12 may process data locally using a local storage, instead of off-chip memory. Such graphics memory 40 may be referred to as on-chip memory. This allows GPU 12 to operate in a more efficient manner by eliminating the need of GPU 12 to read and write data via a bus, which may experience heavy bus traffic and associated contention for bandwidth. In some instances, however, GPU 12 may not include a separate memory, but instead utilize system memory 10 via a bus. Graphics memory 40 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

In some examples, GPU 12 may store a fully formed image in system memory 10. Display processor 14 may retrieve the image from system memory 10 and/or output buffer 16 and output values that cause the pixels of display 8 to illuminate to display the image. Display 8 may be the display of computing device 2 that displays the image content generated by GPU 12. Display 8 may be a liquid crystal display (LCD), an organic light emitting diode display (OLED), a cathode ray tube (CRT) display, a plasma display, or another type of display device.

In accordance with aspects of the present disclosure, GPU 12 may include a first plurality of graphics processing hardware units and a second plurality of graphics processing hardware units. GPU 12 may be configured to perform 3D graphics processing in accordance with a 3D graphics pipeline using the first plurality of graphics processing hardware units. GPU 12 may further be configured to perform a 2D graphics operation using the second plurality of graphics processing hardware units not used in performing the 3D graphics processing and one or more graphics processing hardware units of the first plurality of graphics processing hardware units of GPU 12.

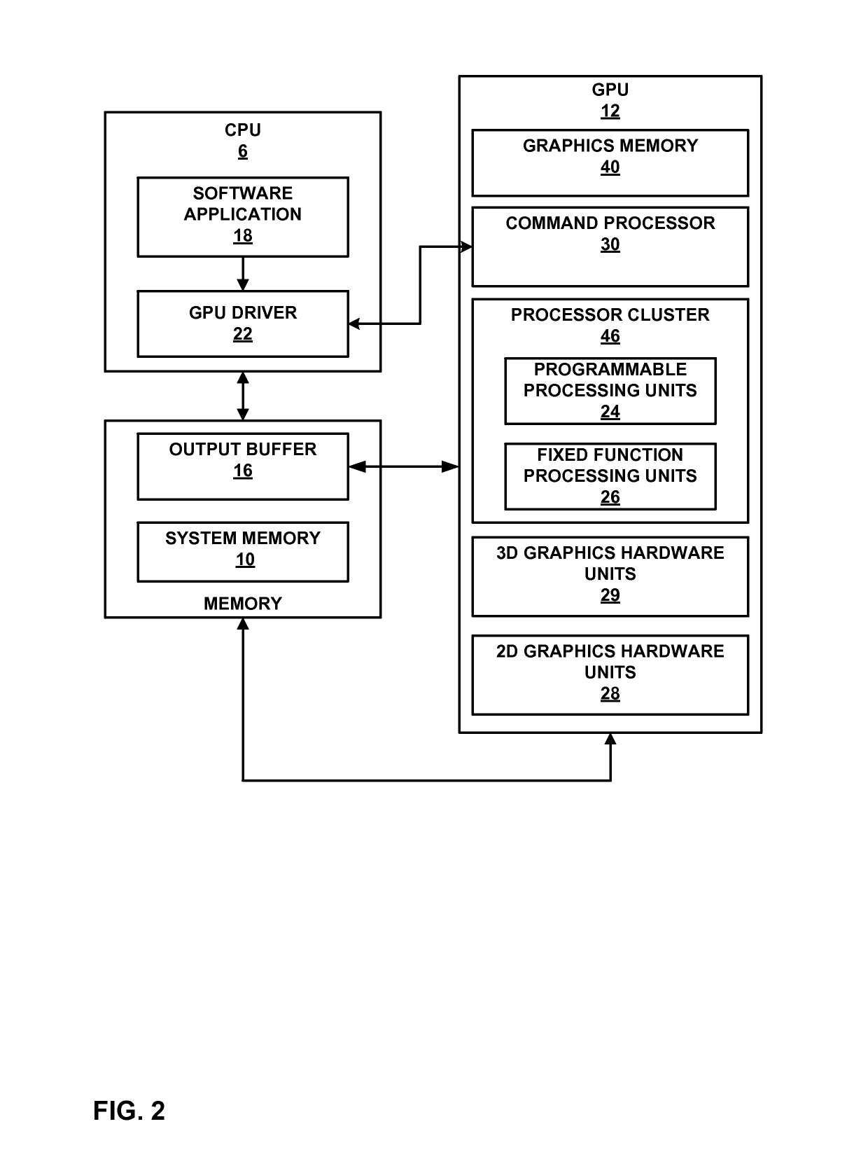

FIG. 2 is a block diagram illustrating example implementations of CPU 6, GPU 12, and system memory 10 of FIG. 1. As shown in FIG. 2, CPU 6 may execute at least one software application 18 and GPU driver 22, each of which may be one or more software applications or services.

Memory available to CPU 6 and GPU 12 may include system memory 10 and output buffer 16. Output buffer 16 may be a part of system memory 10 or may be separate from system memory 10. Output buffer 16 may store rendered image data, such as pixel data, as well as any other data. Output buffer 16 may also be referred to as a framebuffer.

Graphics memory 40 may include on-chip storage or memory that is physically integrated into the integrated circuit chip of GPU 12. If graphics memory 40 is on-chip, GPU 12 may be able to read values from or write values to graphics memory 40 more quickly than reading values from or writing values to system memory 10 via a system bus.

Output buffer 16 stores destination pixels for GPU 12. Each destination pixel may be associated with a unique screen pixel location. In some examples, output buffer 16 may store color components and a destination alpha value for each destination pixel. For example, output buffer 16 may store Red, Green, Blue, Alpha (RGBA) components for each pixel where the “RGB” components correspond to color values and the “A” component corresponds to a destination alpha value (e.g., an opacity value for image compositing). Although output buffer 16 and system memory 10 are illustrated as being separate memory units, in other examples, output buffer 16 may be part of system memory 10. Further, output buffer 16 may also be able to store any suitable data other than pixels.

Software application 18 may be any application that utilizes the functionality of GPU 12. For example, software application 18 may be a GUI application, an operating system, a portable mapping application, a computer-aided design program for engineering or artistic applications, a video game application, or another type of software application that uses 2D or 3D graphics.

Software application 18 may include one or more drawing instructions that instruct GPU 12 to render a graphical user interface (GUI) and/or a graphics scene. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

Software application 18 may invoke GPU driver 22, to issue one or more commands to GPU 12 for rendering one or more graphics primitives into displayable graphics images. For example, software application 18 may invoke GPU driver 22 to provide primitive definitions to GPU 12. In some instances, the primitive definitions may be provided to GPU 12 in the form of a list of drawing primitives, e.g., triangles, rectangles, triangle fans, triangle strips, etc. The primitive definitions may include vertex specifications that specify one or more vertices associated with the primitives to be rendered. The vertex specifications may include positional coordinates for each vertex and, in some instances, other attributes associated with the vertex, such as, e.g., color attributes, normal vectors, and texture coordinates. The primitive definitions may also include primitive type information (e.g., triangle, rectangle, triangle fan, triangle strip, etc.), scaling information, rotation information, and the like.

GPU driver 22 may provide low overhead 2D graphics commands for driver programming. GPU driver 22 may also provide light 2D and 3D graphics operation synchronization mechanisms for less polling and waiting for 2D and 3D graphics operation synchronization at the software level.

Based on the instructions issued by software application 18 to GPU driver 22, GPU driver 22 may formulate one or more commands that specify one or more operations for GPU 12 to perform in order to render the primitive. When GPU 12 receives a command from CPU 6, GPU 12 may execute a 3D graphics processing pipeline using processor cluster 46 and 3D graphics hardware units 29 to decode the command and to configure a 3D graphics processing pipeline to perform the operation specified in the command. For example, an input-assembler in the 3D graphics processing pipeline may read primitive data and assemble the data into primitives for use by the other 3D graphics pipeline stages in a 3D graphics processing pipeline. After performing the specified operations, the 3D graphics processing pipeline outputs the rendered data to output buffer 16 associated with a display device. In some examples, the 3D graphics processing pipeline may include fixed function logic and/or be executed on programmable shader cores.

In some examples, a 3D graphics processing pipeline may include one or more of a vertex shader stage, a hull shader stage, a domain shader stage, a geometry shader stage, and a pixel shader stage. These stages of the 3D graphics processing pipeline may be considered shader stages. These shader stages may be implemented as one or more shader programs that execute on processor cluster 46 in GPU 12.

Processor cluster 46 may include one or more programmable processing units and/or one or more fixed function processing units. A programmable processing unit may include, for example, a programmable shader unit that is configured to execute one or more shader programs that are downloaded onto GPU 12 from CPU 6. In some examples, the programmable shader units may be referred to as “shader processors” or “unified shaders,” and may perform geometry, vertex, pixel, or other shading operations to render graphics. The shader units may each include one or more components for fetching and decoding operations, one or more ALUs for carrying out arithmetic calculations, one or more memories, caches, and registers.

A shader program, in some examples, may be a compiled version of a program written in a high-level shading language, such as, e.g., an OpenGL Shading Language (GLSL), a High Level Shading Language (HLSL), a C for Graphics (Cg) shading language, etc. In some examples, a programmable shader unit may include a plurality of processing units that are configured to operate in parallel, e.g., an SIMD pipeline. A programmable shader unit may have a program memory that stores shader program instructions and an execution state register, e.g., a program counter register that indicates the current instruction in the program memory being executed or the next instruction to be fetched. The programmable shader units in processor cluster 46 may include, for example, vertex shader units, pixel shader units, geometry shader units, hull shader units, domain shader units, compute shader units, and/or unified shader units.

GPU 12 may designate the programmable shader units to perform a variety of shading operations such as vertex shading, hull shading, domain shading, geometry shading, pixel shading, and the like by sending commands to the programmable shader units to execute one or more of a vertex shader stage, a hull shader stage, a domain shader stage, a geometry shader stage, and a pixel shader stage in a graphics processing pipeline. In some examples, GPU driver 22 may cause a compiler executing on CPU 6 to compile one or more shader programs, and to download the compiled shader programs onto the programmable shader units contained within GPU 12.

A fixed function processing unit may include hardware that is hard-wired to perform certain functions. Although the fixed function hardware may be configurable, via one or more control signals for example, to perform different functions, the fixed function hardware typically does not include a program memory that is capable of receiving user-compiled programs. In some examples, the fixed function processing units in processor cluster 46 may include, for example, processing units that perform raster operations, such as, e.g., depth testing, scissors testing, alpha blending, etc.

3D graphics hardware units 29 may include additional hardware units that are configured to support 3D processing via performance of the 3D graphics pipeline by processor cluster 46 to process 3D graphics operations to render 3D graphical objects through the 3D graphics pipeline. For example, 3D graphics hardware units 29 may include memory arbitration blocks, caches, registers, hardware for controlling processor cluster 46, and the like.

Based on the instructions issued by software application 18 to GPU driver 22, GPU driver 22 may also formulate one or more commands that specify one or more 2D graphics operations for GPU 12 to perform. Software application 18 may invoke GPU driver 22, to issue one or more commands to GPU 12 for performing a 2D graphics operation to render geometric shapes such as lines, rectangles, polygons, and the like onto a 2D plane, such as a bitmap, or to copy pixels from one plane to another. A drawing in 2-D graphics may be composed of paths, which are used to define geometry in the drawing. A path defines the duration of a pen or a paint brush over a drawing surface and may be stroked (i.e., defining the outline of a path's shape with lines) and/or filled (i.e., applying color, gradient, and/or texture to a shape's interior. A bitmap may represent pixels which may have attributes. Attributes for basic 2D graphics may include, for each pixel, a color value and a pair of coordinates for a source buffer.

One common 2D graphics operation is a bit block transfer (bitBLT) function, which is a function that performs a block transfer of bits (e.g., color data, pixel data, etc.) from a source device context to a destination device context, such as a transfer of a rectangular block of pixel data from a source memory location to a destination memory location, such as from system memory 10 to graphics memory 40, from graphics memory to output buffer 16, from a first block of memory locations in system memory 10 to a second block of memory locations in system memory 10, and the like. For example, GPU 12 may perform the bitBLT function to transfer a block of bits representing an image or surface from system memory 10 or graphics memory 40 into output buffer 16 for display by display 8.

BitBLT functions may sometimes involve not only a data block transfer, but also an operation performed on the data. For example, while the data block is being transferred from one memory location to another, GPU 12 may apply a transparency operation to the data block. Other operations, such as raster operations (ROPs), scaling and filtering operations, shrinking operations, alpha blending operations, and color conversion operations may be performed as well, depending on the commands issued to GPU 12. GPU 12 may perform any combination of these operations while performing a bitBLT operation.

For example. Software application 18 may call a bitBLT function to transfer a block of pixels. Software application 18 may indicate a source block of bits to be transferred, the destination block of bits, and one or more raster operations to be performed on the block of bits. For example, the one or more raster operations may indicate how the color data of the source block of bits is to be combined with the color data of the destination block of bits for the destination rectangle to achieve its final color. GPU driver 22 may, in turn, issue commands to GPU 12 to perform the specified bitBLT function.

GPU 12 may perform 2D graphics operations using a combination of hardware modules of GPU 12 used to perform 3D operations in accordance with a 3D pipeline together with dedicated 2D graphics hardware modules. For example, GPU 12 may use 2D graphics hardware units 28, which includes dedicated 2D graphics hardware logic, to perform the data block transfer of a bitBLT operation and may use one or more of programmable processing units 24 and fixed function processing units 26 of processor cluster 46 to perform raster operations, scaling operations, blending operations, and/or color conversion operations on the data block.

If GPU 12 performs a 2D graphics operation using a portion (i.e., fewer than all) of hardware modules in GPU 12 used to perform 3D operations, GPU 12 may power down or clock gate the hardware modules in GPU 12 that are not used to perform the 2D graphics operation to decrease power usage. GPU driver 22 may determine, based on the 2D graphics function called by software application 18 to invoke a 2D graphics operation, which portions of 3D graphics hardware units 29 and processor cluster 46 that GPU 12 may use to perform the 2D graphics operation, and which portions of 3D graphics hardware units 29 and processor cluster 46 that GPU 12 does not use to perform the invoked 2D graphics operation and may therefore be powered off or clock gated.

For example, if software application 18 invokes a bitBLT operation for transferring a bit block that also applies an operation to the bit block, such as a transparency operation, a raster operation, a scaling operation, a shrinking operation, an alpha blending operation, a color conversion operation, and the like, GPU driver 22 may determine, based at least in part on the 2D graphics operation issued by software application 18, and more specifically based at least in part on the operation to be applied to the bit block, an operation mode of GPU 12 out of a plurality of operation modes of GPU 12.

For each of the operation modes of GPU 12, GPU driver 22 may direct GPU 12 to enable a portion of the hardware used by GPU 12 to perform 3D graphics processing (i.e., the portions of 3D graphics hardware units 29 and processor cluster 46) so that GPU 12 may use that portion of the hardware together with 2D graphics hardware units 28 to perform 2D graphics operations. GPU driver 22 may also disable (i.e., power off or clock gate) a portion of the hardware used by GPU 12 to perform 3D graphics processing that is not used by the GPU to perform 2D graphics operations. For example, in one operation mode, GPU driver 22 may cause GPU 12 to enable fixed function processing units 26 to perform 2D graphics operations, but may cause GPU 12 to power off programmable processing units 24 because GPU 12 does not use programmable processing units 24 to perform 2D graphics operations.

GPU driver 22 may, based on the instructions issued by software application 18 to GPU driver 22, generate a command stream that defines a set of operations for execution by GPU 12. GPU driver 22 may generate a command stream to be executed by GPU 12 that causes viewable content to be displayed on display 8. For example, GPU driver 22 may generate a command stream that provides instructions for GPU 12 to render graphics data that may be stored in output buffer 16 for display at display 8. In this example, GPU driver 22 may generate a command stream that is executed by GPU 12.

GPU 12 may include command processor 30 that may receive the command stream from GPU driver 22. Command processor 30 may be any combination of hardware and software configured to receive and process one or more command streams. As such, command processor 30 is a stream processor. In some examples, instead of command processor 30, any other suitable stream processor may be usable in place of command processor 30 to receive and process one or more command streams and to perform the techniques disclosed herein. In one example, command processor 30 may be a hardware processor. In the example shown in FIG. 2, command processor 30 may be included in GPU 12. In other examples, command processor 30 may be a unit that is separate from CPU 6 and GPU 12. Command processor 30 may also be known as a stream processor, command/stream processor, and the like to indicate that it may be any processor configured to receive streams of commands and/or operations.

Command processor 30 may process one or more command streams including scheduling operations included in the one or more command streams for execution by GPU 12. Specifically, command processor 30 may process the one or more command streams and schedule the operations in the one or more command streams for execution by processor cluster 46. In operation, GPU driver 22 may send to command processor 30 a command stream comprising a series of operations to be executed by GPU 12. Command processor 30 may receive the stream of operations that comprise the command stream and may process the operations of the command stream sequentially based on the order of the operations in the command stream and may schedule the operations in the command stream for execution by one or more of 2D graphics hardware units 28, 3D graphics hardware units 29, an processor cluster 46.

As discussed above, software application 18 may issue instructions to perform both 2D graphics operations as well as 3D graphics operations. GPU driver 22 may provide the same interface to GPU 12 for software application 18 to invoke 2D graphics operations and 3D graphics operations, and GPU driver 22 may generate command streams that include both 2D graphics operations as well as 3D graphics operations. In one example, GPU driver 22 may separate 2D graphics operations and 3D graphics operations into separate command streams, so that a first command stream may include only 2D graphics operations while a second command stream may include only 3D graphics operations. In another example, GPU driver 22 may include both 2D graphics operations and 3D graphics operations in a single command stream in the order in which the 2D graphics operations and the 3D graphics operations were invoked by software application 18.

Command processor 30 may be able to process both 2D graphics operations and 3D graphics operations by switching between performing 2D graphics operations and 3D graphics operations. For example, GPU driver 22 may direct command processor 30 to switch from processing a 3D graphics operation to processing a 2D graphics operation. Command processor 30 may, in response to receiving a command from GPU driver 22 to switch from processing the 3D graphics operation to processing the 2D graphics operation, perform a context switch. Command processor 30 may interrupt processing of the 3D graphics operation and, upon interruption of the processing of the 3D graphics operation, commence processing of the 2D graphics operation.

Command processor 30 may interrupt GPU 12's processing of the 3D graphics operation, including saving context information of the 3D graphics operation into context registers in GPU 12. For example, command processor 30 may save configuration information for the 3D graphics pipeline, such as color formats, memory addresses, shader instructions, 3D graphics pipeline state information, and the like, such that when, at a later point, command processor 30 performs a switch back to processing the 3D graphics operation, command processor 30 may utilize the configuration information saved in the context registers to resume processing of the 3D graphics operation according to the 3D graphics pipeline without having to completely flush the 3D graphics pipeline. For example, command processor 30 may restore 3D graphics pipeline configuration information, color formats, memory addresses, shader instructions, and the like, so that GPU 12 may resume processing of the 3D graphics operation without completely flushing the 3D graphics pipeline. Similarly, command processor 30 may interrupt GPU 12's processing of 2D graphics operations by saving contextual information for processing 2D graphics operations into context registers in GPU 12 and performing a switch to process 3D graphics operations.

Command processor 30 may, by performing switching as described above, enable GPU 12 to process 2D graphics operations as well as 3D graphics operations issued by software application 18 in the order in which the 2D and 3D graphics operations were invoked by software application 18. By saving configuration information into context registers, command processor 30 may enable GPU 12 to seamlessly switch between 2D and 3D graphics processing.

In some examples, GPU 12 may be able to smoothly switch between performing 2D graphics operations and 3D graphics operations without performing a context switch. GPU 12 may include separate 2D state registers for storing state information for 2D graphics operations and 3D state registers for storing state information for 3D graphics operations, such as 3D graphics pipeline configuration information, color formats, memory addresses, shader instructions, and the like. When switching between 2D graphics operations and 3D graphics operations, GPU driver 22 and/or GPU 12 may save the state information in the appropriate state registers, such that GPU 12 may be able to smoothly switch between performing 2D graphics operations and 3D graphics operations. As such, the 2D and 3D stage registers may enable GPU 12 to seamlessly switch between 2D and 3D graphics processing without completely flushing the 3D graphics pipeline.

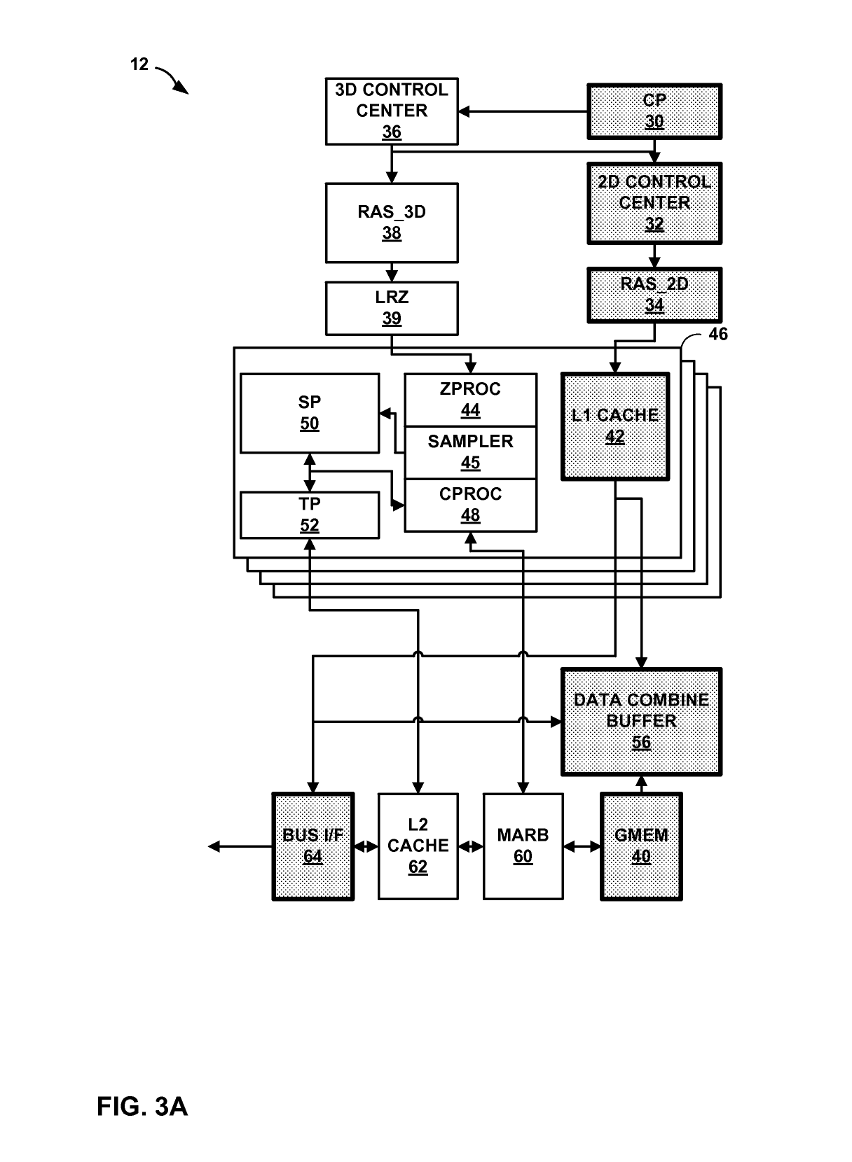

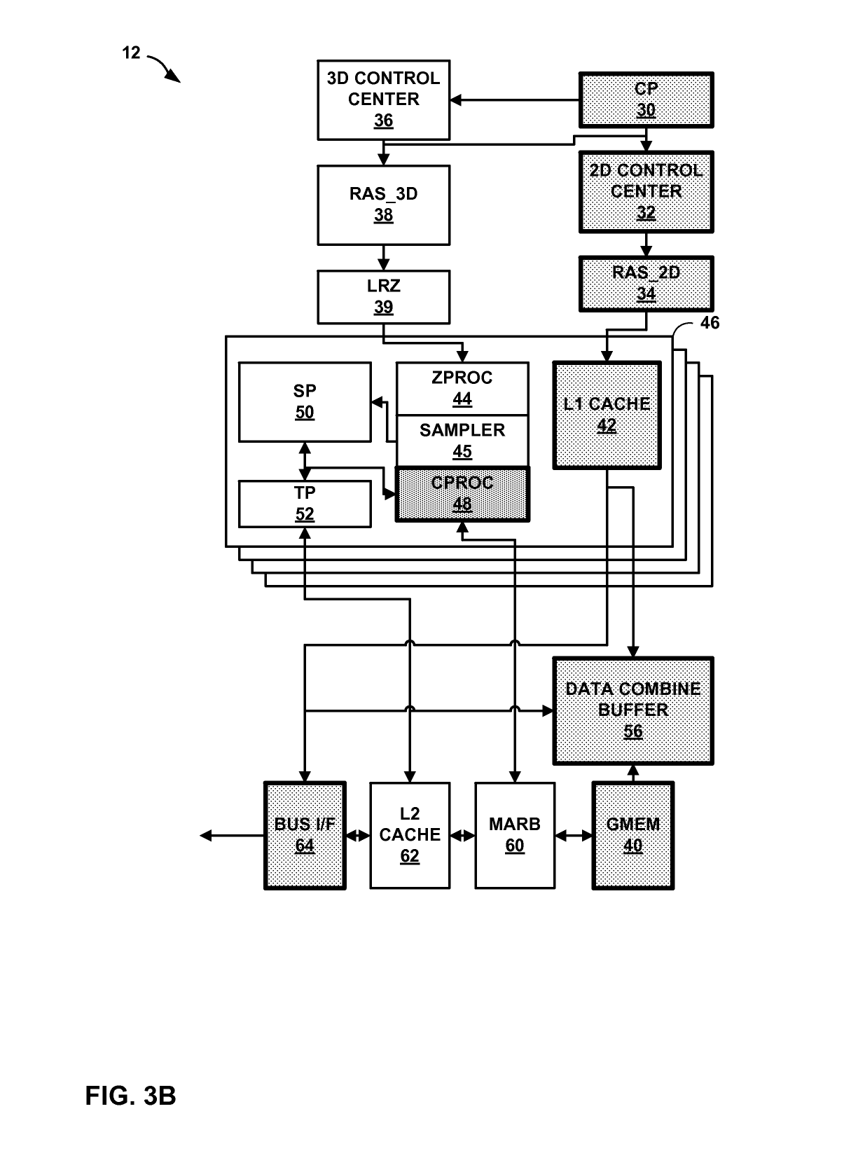

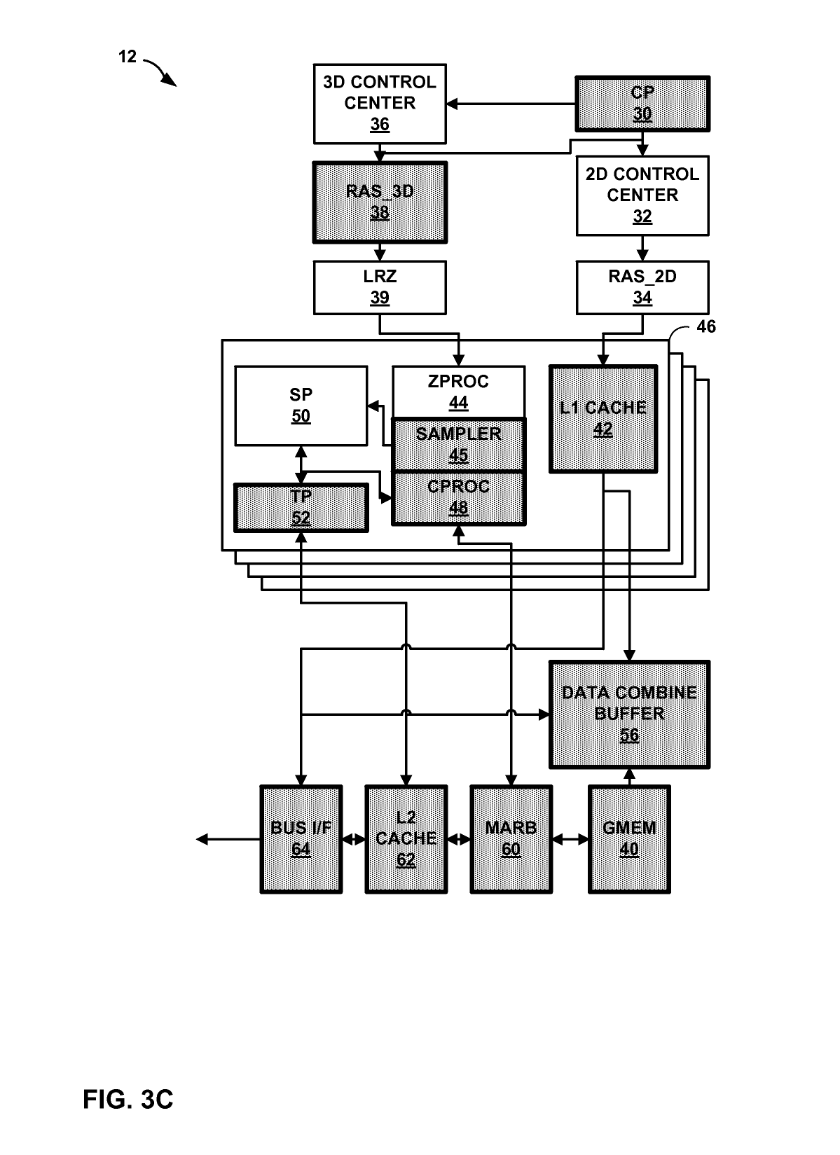

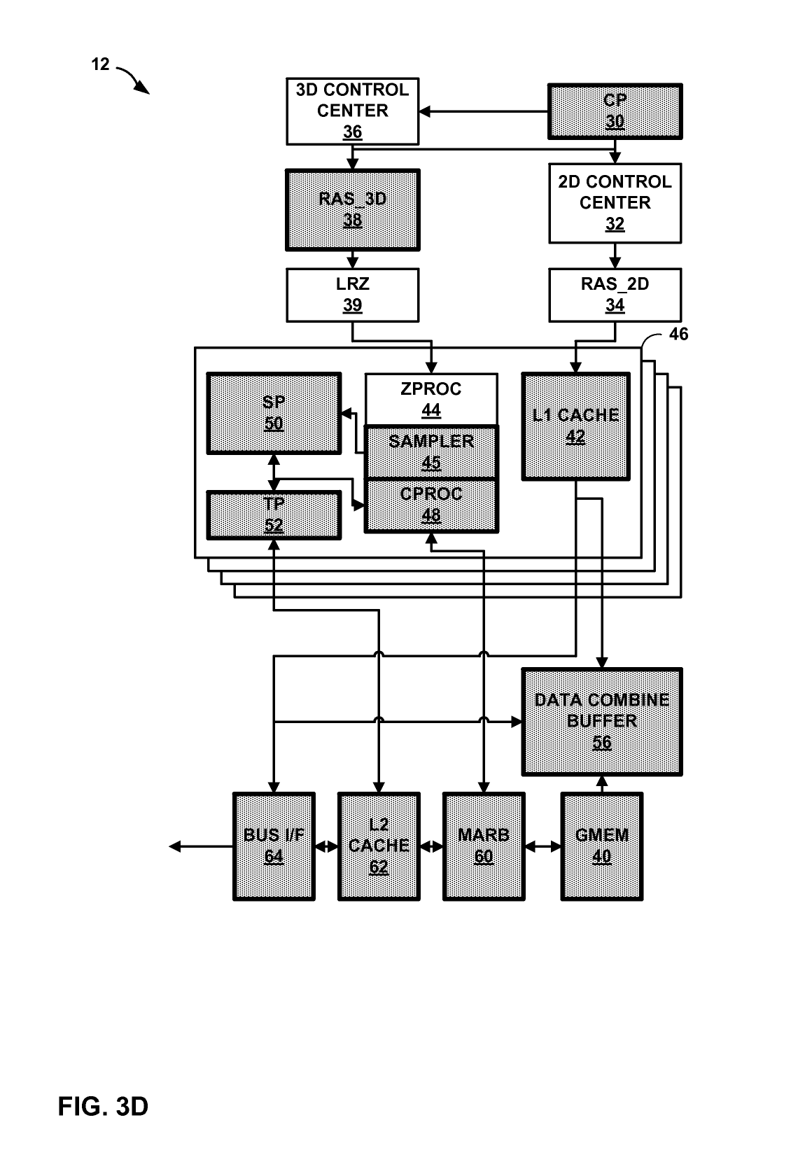

FIGS. 3A-3D are block diagrams illustrating operating modes of GPU 12 in further detail. As discussed above, GPU driver 22 may, based on the graphics operation invoked by software application 18, determine an operating mode out of a plurality of operating modes for GPU 12. Each of FIGS. 3A-3D may illustrate one exemplary operating mode for GPU 12 that is determined by GPU driver 22 based on the operation GPU 12 performs as invoked by software application 18. In FIGS. 3A-3D, components that are powered up and used in performing the exemplary graphics operation are shaded, while components that are powered down and/or clock gated because they are not used in performing the exemplary graphics operation are not shaded. As shown in FIG. 3A, GPU 12 may operate in a first mode to perform bit block transfer operations as well as memory resolve and unresolved operations.

GPU 12 may include command processor (CP) 30, 2D control center 32, 2D 2D raster and tile address generator (RAS_2D) 34, 3D control center 36, 3D raster unit (RAS_3D) 38, low resolution Z (LRZ) block 39, processor cluster 46, data combine buffer 56, graphics memory (GMEM) 40, memory arbitration blocks (MARB) 60, level 2 (L2) cache 62, and memory bus interface (BUS I/F) 64. Processor cluster 46 may include a plurality of processors, where each processor of processor cluster 46 includes shader processor (SP) 50, texture processor (TP) 52, depth processor (ZPROC) 44, pixel sampler 45, color processor (CPROC) 48, and pixel level 1 (L1) cache 42.

2D control center 32 may receive a 2D drawing command from command processor 30 and may generate source read requests and destination read requests block by block or quad by quad. 2D control center 32 may also read and write data to and from pixel L1 cache 42, on-chip graphics memory 40, and system memory 10. 2D control center 32 may also distribute blocks of graphical data or quads (e.g., 2×2 pixels) to pixel L1 cache 42 and depth processor 44, pixel sampler 45, and color processor 48, and may guide the blocks or quads writes from Pixel L1 cache 42 and depth processor 44, pixel sampler 45, and color processor 48.

3D control center 36 may receive a 3D drawing command from command processor 30 and may control 3D raster unit 38, LRZ block 39, processor cluster 46 and shader processor 50, texture processor 52, depth processor 44, pixel sampler 45, color processor 48, and pixel L1 cache 42 included in processor cluster 46 to perform the 3D drawing command according to a 3D graphics pipeline.

LRZ block 39 may be used to accelerate depth testing of a block of pixels at time, such as during a binning pass to perform visibility tests of primitives by performing low resolution depth testing of blocks of pixels instead of relatively higher resolution depth testing of individual pixels. Depth processor 44 may perform depth-related processing, such as pixel-level depth testing during 3D graphics rendering, such as after GPU 12 performs pixel shading. Pixel sampler 45 may perform sampling related operations. Color processor 48 may perform pixel format conversion as well as pixel blending during processing of primitives through a graphics pipeline. Shader processor 50 may send texture data to texture processor 52 for processing. Texture processor 52 may operate on the texture data and may send the results of operating on the texture data to shader processor 50 for further processing. Pixel L1 cache 42 may cache pixel color and depth data of output buffer 16. Data combine buffer 56 may a first-in-first-out (FIFO) stack that combines data shared between color cache unit 42 of processor cluster 46.

Software application 18 may invoke a bitBLT operation that simply transfers a bit block from a source location (i.e., a source block of pixels of a surface) to a destination location (i.e., a destination block of pixels of a surface). GPU driver 22 may determine, based on the 2D graphics operation invoked by software application, a mode of operation for GPU 12. As shown in FIG. 3A, GPU driver 22 may determine a first mode of operation for GPU 12 to perform the bitBLT operation that transfers a bit block from a source location to a destination location. In the first mode of operation, GPU 12 may enable command processor 30, 2D control center 32, 2D raster and tile address generator 34, L1 cache unit 42, data combine buffer 56, graphics memory 40, and memory bus interface 64. In the first mode of operation, GPU 12 may also disable 3D control center 36, 3D raster unit 38, LRZ block 39, shader processor 50, texture processor 52, depth processor 44, pixel sampler 45, color processor 48, memory arbitration blocks 60, and L2 cache 62, including powering off or clock gating those hardware modules.

To perform the bitBLT operation, command processor 30 may decode the command received from GPU driver 22 to perform the bitBLT operation, and may communicate the 2D graphics operation to 2D control center 32. 2D control center 32 may generate the read requests for the bit block from the source location and may also generate the write request for the bit block to the destination location. For example, the source location and the destination location may be any of pixel L1 cache 42, data combine buffer 56, graphics memory 40, and/or one or more surfaces stored within system memory 10. If the source location or the destination location of the bitBLT operation is system memory 10, GPU 12 may access system memory 10 via memory bus interface 64. GPU 12 may, based on the read and write requests generated by the 2D control center 32, perform the bit block transfer from the source location to the destination location.

Because the bit block transfer operation is performed using dedicated 2D graphics processing hardware modules such as 2D control center 32, the performance of the bit block transfer operation is not limited by the 3D datapath of 3D graphics processing hardware modules. As such, the bit block operation may be able to saturate memory interfaces to more efficiently transfer the bit block between memory locations.

As shown in FIG. 3B, GPU 12 may operate in a second mode to perform simple bit block transfer operations with a blending operation. Examples of blending operations may include alpha blending, compositing, overlaying, Porter-Duff compositing, and the like. Software application 18 may invoke a bitBLT operation that transfers a bit block from a source location to a destination location as well as a blending operation to blend the colors of the bit block from the source location with colors of the bit block in the destination location. GPU driver 22 may determine, based on the 2D graphics operation invoked by software application, a mode of operation for GPU 12. As shown in FIG. 3B, GPU driver 22 may determine a second mode of operation for GPU 12 to perform the bitBLT operation that transfers a bit block from a source location to a destination location and the blending operation that blends the bit block from the source location with the bit block in the destination location. In the second mode of operation, GPU 12 may enable command processor 30, 2D control center 32, 2D raster and tile address generator 34, color processor 48, pixel L1 cache 42, data combine buffer 56, graphics memory 40, and memory bus interface 64. In the second mode of operation, GPU 12 may also disable 3D control center 36, 3D raster unit 38, LRZ block 39, shader processor 50, texture processor 52, depth processor 44, pixel sampler 45, memory arbitration blocks 60, and L2 cache 62, including powering off or clock gating those hardware modules.

To perform the bitBLT operation together with the blending operation, command processor 30 may decode the command received from GPU driver 22 to perform the bitBLT operation and the blending operation, and may communicate the 2D graphics operations to 2D control center 32. 2D control center 32 may generate the read requests for the bit block from the source location and may also generate the write request for the bit block to the destination location. For example, the source location and the destination location may be any of color cache unit42, data combine buffer 56, graphics memory 40, and/or system memory 10. If the source location or the destination location of the bitBLT operation is system memory 10, GPU 12 may access system memory 10 via memory bus interface 64. GPU 12 may, based on the read and write requests generated by the 2D control center 32, perform the bit block transfer from the source location to the destination location.

GPU 12 may retrieve the color information of the bit block from the source location and the color information of the bit block of the destination location from pixel L1 cache 42, which may cache color information. Color processor 48 may receive the color information for the respective bit block from the source location and the bit block of the destination location. Color processor 48 may perform any necessary color format conversion and may perform blending of the colors, such as alpha blending, according to the blending operation specified by GPU driver 22. For example, color processor 48 may convert color formats from non-linear color space to linear color space, or vice versa, or from any color format to any other color format, such as from YUV to RGBA. GPU 12 may write the resulting bit block with the blended colors in the destination location.

As shown in FIG. 3C, GPU 12 may operate in a third mode to perform simple bit block transfer operations with scaling and filtering operations. For example, GPU 12 may scale and filter bit blocks in order to downscale or upscale graphical wallpapers or other blocks of pixels. Software application 18 may invoke a bitBLT operation that transfers a bit block from a source location to a destination location as well as a scaling operation that scales the bit block from the source location. GPU driver 22 may determine, based on the 2D graphics operation invoked by software application, a mode of operation for GPU 12. As shown in FIG. 3C, GPU driver 22 may determine a third mode of operation for GPU 12 to perform the bitBLT operation that transfers a bit block from a source location to a destination location and the scaling operation. In the third mode of operation, GPU 12 may enable command processor 30, 2D control center 32, 3D raster unit 38, pixel sampler 45, color processor 48, pixel L1 cache 42, texture processor 52, data combine buffer 56, graphics memory 40, memory arbitration blocks, L2 cache 62, and memory bus interface 64. In the third mode of operation, GPU 12 may also disable 2D control center 32, 2D raster and tile address generator 34, LRZ block 39, shader processor 50, and depth processor 44, including powering off or clock gating those hardware modules.

To perform the bitBLT operation along with the scaling and filtering operation, command processor 30 may decode the command received from GPU driver 22 to perform the bitBLT operation and the scaling and filtering operation, and may communicate the 2D graphics operations to 3D raster unit 38. 3D raster unit 38 may generate the read requests for the bit block from the source location and may also generate the write request for the bit block to the destination location. For example, the source location and the destination location may be any of pixel L1 cache 42, data combine buffer 56, graphics memory 40, and/or system memory 10. If the source location or the destination location of the bitBLT operation is system memory 10, GPU 12 may access system memory 10 via memory bus interface 64. GPU 12 may, based on the read and write requests generated by the 3D raster unit 38, perform the bit block transfer from the source location to the destination location.

3D raster unit 38 may also direct texture processor 52 to perform scaling and filtering of the bit block. L2 cache 62 may cache the bit block to be scaled and filtered. Texture processor 52 may read the bit block from L2 cache 62 and may perform scaling and filtering of the bit block, and may send the scaled and filtered bit block through color processor 48 so that GPU 12 may write the resulting scaled and filtered bit block to the destination location.

As shown in FIG. 3D, GPU 12 may operate in a fourth mode to perform additional 2D graphics processing which may utilize shader processors 50. GPU 12 may operate in the fourth mode to perform additional 2D image rendering with arbitrary transforms as well as shader image rendering, including gradient and radical shading. As shown in FIG. 3D, GPU 12 may enable shader processor 50 and may use shader processor 50 in performing these graphics operations. Furthermore, GPU 12 may also operate in the fourth mode to perform 3D graphics processing operations in accordance with a 3D graphics processing pipeline.

As shown in FIGS. 3A-3D, the functionality of GPU 12 in the first operation mode illustrated by FIG. 3A is a subset of the functionality of GPU 12 in the second, third, and fourth operation modes illustrated by FIGS. 3B, 3C, and 3D, respectively. Similarly, the functionality of GPU 12 in the second operation mode illustrated by FIG. 3B is a subset of the functionality of GPU 12 in the third, and fourth operation modes illustrated by FIGS. 3C, and 3D, respectively. Further, the functionality of GPU 12 in the third operation mode illustrated by FIG. 3C is a subset of the functionality of GPU 12 in the fourth operation mode illustrated by FIG. 3D. In this way, GPU 12 in the second, third, or fourth operation modes may still be able to perform the functionality of GPU 12 in the first mode, GPU 12 in the third or fourth operation modes may still be able to perform the functionality of GPU 12 in the second mode, and GPU 12 in the fourth operation modes may still be able to perform the functionality of GPU 12 in the third mode.

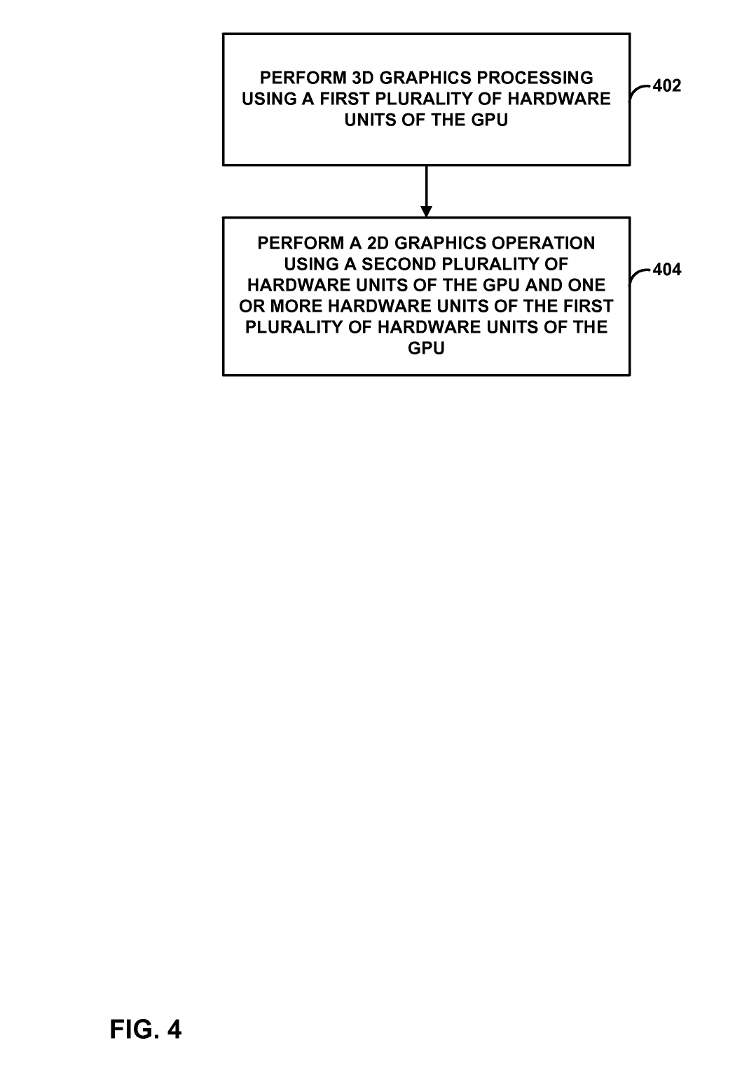

FIG. 4 is a flow chart illustrating an example operation of GPU 12 in further detail. As shown in FIG. 4, GPU 12 may perform graphics processing in accordance with a 3D graphics pipeline using a first plurality of graphics processing hardware units of GPU 12 (402). GPU 12 may further perform 2D graphics operation using a second plurality of graphics processing hardware units of GPU 12 not used in performing the 3D graphics processing and one or more graphics processing hardware units of the first plurality of graphics processing hardware units of GPU 12 (404).

In some examples, GPU 12 may determine, based at least in part on the 2D graphics operation to be performed by GPU 12, the one or more graphics processing hardware units of the first plurality of graphics processing hardware units that are used in performing the 2D graphics operation. In some examples, GPU 12 may save context information associated with the 3D graphics processing in accordance with the 3D graphics pipeline. GPU 12 may further switch a context of GPU 12 to perform the 2D operation. Subsequent to performing the 2D operation, GPU 12 may switch the context of GPU 12 to resume performance of the 3D graphical processing based at least in part on the saved context information.

In some examples, the two-dimensional graphics operation comprises a bit block transfer operation to transfer a bit block from a source location to a destination location. In some examples, the two-dimensional graphics operation further comprises a blending operation to blend the source bit block with a destination bit block at the destination location. In some examples, the two-dimensional graphics operation further comprises a scaling operation to scale and filter the bit block.

In some examples, performing, by GPU 12, the 2D graphics operation includes GPU 12 performing a clear operation to write a default value to the destination location. The second plurality of graphics processing hardware units comprises pixel level 1 cache 42. In some examples, performing, by GPU 12, the 2D graphics operation includes GPU 12 performing a bit block transfer operation to transfer a block of pixels from a source location to a destination location. The second plurality of graphics processing hardware units comprises pixel level 1 cache 42.

In some examples, performing, by GPU 12, the 2D graphics operation includes performing, by color processor 48 of GPU 12, a bit block transfer with blending operation to blend a first block of pixels from a source location with a destination block of pixels at a destination location. The second plurality of graphics processing hardware units comprises pixel level 1 cache 42, and the one or more graphics processing hardware units of the first plurality of graphics processing hardware units comprises color processor 48. In some examples, performing, by GPU 12, the 2D graphics operation includes performing, by color processor 48 of GPU 12, a format conversion of a block of pixels from a first color format to a second color format and performing, by GPU 12, a bit block transfer operation to transfer the format converted block of pixels to a destination location. The second plurality of graphics processing hardware units comprises pixel level 1 cache 42, and the one or more graphics processing hardware units of the first plurality of graphics processing hardware units comprises color processor 48. In some examples, performing, by GPU 12, the 2D graphics operation includes performing, by texture processor 52 of GPU 12, a scaling operation to scale a block of pixels and performing, by GPU 12, a bit block transfer operation to transfer the scaled block of pixels to a destination location. The second plurality of graphics processing hardware units comprises pixel level 1 cache 42, and the one or more graphics processing hardware units of the first plurality of graphics processing hardware units comprises color processor 48 and texture processor 52.

In some examples GPU 12 may power down portions of the first plurality of graphics processing hardware units of the GPU that are not used in performing the 2D graphics operations. In some examples, powering down of the first plurality of graphics processing hardware units of the GPU that are not used in performing the 2D graphics operations may further include powering down, by GPU 12, one or more shader processors of GPU 12.

In some examples, the one or more graphics processing hardware units of the first plurality of graphics processing hardware units of GPU 12 includes fewer than all of the first plurality of graphics processing hardware units of GPU 12.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

1. A method for graphics processing comprising:
performing, by a graphics processing unit (GPU), three-dimensional (3D) graphics processing in accordance with a 3D graphics pipeline using a first plurality of graphics processing hardware units of the GPU; and
performing, by the GPU, a two-dimensional (2D) graphics operation using a second plurality of graphics processing hardware units of the GPU not used in performing the 3D graphics processing and one or more graphics processing hardware units of the first plurality of graphics processing hardware units of the GPU.

2. The method of claim 1, further comprising:
determining, by the GPU, based at least in part on the 2D graphics operation to be performed by the GPU, the one or more graphics processing hardware units of the first plurality of graphics processing hardware units that are used in performing the 2D graphics operation.

3. The method of claim 1, wherein performing, by the GPU, the 2D graphics operation comprises performing, by the GPU, the 2D operation without using a shader processor of the first plurality of graphics processing hardware units of the GPU.

4. The method of claim 1, further comprising:
saving, by the GPU, context information associated with the 3D graphics processing in accordance with the 3D graphics pipeline;
switching, by the GPU, a context of the GPU to perform the 2D graphics operation; and
subsequent to performing the 2D graphics operation, switching, by the GPU, the context of the GPU to resume performance of the 3D graphical processing based at least in part on the saved context information.

5. The method of claim 1, wherein:
performing, by the GPU, the 2D graphics operation includes performing a clear operation to write a default value to a destination location; and
the second plurality of graphics processing hardware units comprises a level 1 cache.

6. The method of claim 1, wherein:
performing, by the GPU, the 2D graphics operation includes performing a bit block transfer operation to transfer a block of pixels from a source location to a destination location; and
the second plurality of graphics processing hardware units comprises a level 1 cache.

7. The method of claim 1, wherein:
performing, by the GPU, the 2D graphics operation includes performing, by a color processor of the GPU, a bit block transfer with blending operation to blend a first block of pixels from a source location with a destination block of pixels at a destination location;
the second plurality of graphics processing hardware units comprises a level 1 cache; and
the one or more graphics processing hardware units of the first plurality of graphics processing hardware units comprises the color processor.

8. The method of claim 1, wherein:
performing, by the GPU, the 2D graphics operation includes performing, by a color processor of the GPU, a format conversion of a block of pixels from a first color format to a second color format and performing, by the GPU, a bit block transfer operation to transfer the format converted block of pixels to a destination location;
the second plurality of graphics processing hardware units comprises a level 1 cache; and
the one or more graphics processing hardware units of the first plurality of graphics processing hardware units comprises the color processor.

9. The method of claim 1, wherein:
performing, by the GPU, the 2D graphics operation includes performing, by a texture processor of the GPU, a scaling operation to scale a block of pixels and performing, by the GPU, a bit block transfer operation to transfer the scaled block of pixels to a destination location;
the second plurality of graphics processing hardware units comprises a level 1 cache; and
the one or more graphics processing hardware units of the first plurality of graphics processing hardware units comprises a color processor and the texture processor.

10. A computing device comprising:
a memory configured to store a two-dimensional (2D) graphics operation; and
a graphics processing unit (GPU) including a first plurality of graphics processing hardware units and a second plurality of graphics processing hardware units, wherein the GPU is configured to perform three-dimensional (3D) graphics processing in accordance with a 3D graphics pipeline using the first plurality of graphics processing hardware units of the GPU, and wherein the GPU is further configured to perform the 2D graphics operation using the second plurality of graphics processing hardware units of the GPU and one or more graphics processing hardware units of the first plurality of graphics processing hardware units.

11. The computing device of claim 10, wherein the GPU is further configured to:
determine, based at least in part on the 2D graphics operation to be performed by the GPU, the one or more graphics processing hardware units of the first plurality of graphics processing hardware units that are used in performing the 2D graphics operation.

12. The computing device of claim 10, wherein the GPU is further configured to perform the 2D operation without using a shader processor of the first plurality of graphics processing hardware units of the GPU.

13. The computing device of claim 10, wherein the GPU is further configured to:
save context information associated with the 3D graphics processing in accordance with the 3D graphics pipeline;
switch a context of the GPU to perform the 2D graphics operation; and
subsequent to performing the 2D graphics operation, switch the context of the GPU to resume performance of the 3D graphical processing based at least in part on the saved context information.

14. The computing device of claim 10, wherein:
the GPU is further configured to perform a clear operation to write a default value to a destination location; and
the second plurality of graphics processing hardware units comprises a level 1 cache.

15. The computing device of claim 10, wherein:
the GPU is further configured to perform a bit block transfer operation to transfer a block of pixels from a source location to a destination location; and
the second plurality of graphics processing hardware units comprises a level 1 cache.

16. The computing device of claim 10, wherein:
the GPU is further configured to perform a bit block transfer with blending operation to blend a first block of pixels from a source location with a destination block of pixels at a destination location;
the second plurality of graphics processing hardware units comprises a level 1 cache; and
the one or more graphics processing hardware units of the first plurality of graphics processing hardware units comprises a color processor.

17. The computing device of claim 10, wherein:
the GPU is further configured to perform a format conversion of a block of pixels from a first color format to a second color format and to perform a bit block transfer operation to transfer the format converted block of pixels to a destination location;
the second plurality of graphics processing hardware units comprises a level 1 cache; and
the one or more graphics processing hardware units of the first plurality of graphics processing hardware units comprises a color processor.

18. The computing device of claim 10, wherein:
the GPU is further configured to perform a scaling operation to scale a block of pixels and to perform a bit block transfer operation to transfer the scaled block of pixels to a destination location;
the second plurality of graphics processing hardware units comprises a level 1 cache; and
the one or more graphics processing hardware units of the first plurality of graphics processing hardware units comprises a color processor and a texture processor.

19. An apparatus for graphics processing, comprising:
means for performing three-dimensional (3D) graphics processing in accordance with a 3D graphics pipeline using a first plurality of graphics processing hardware units; and
means for performing a two-dimensional (2D) graphics operation using a second plurality of graphics processing hardware units not used in performing the 3D graphics processing and one or more graphics processing hardware units of the first plurality of graphics processing hardware units.

20. The apparatus of claim 19, further comprising:
means for determining, based at least in part on the 2D graphics operation to be performed, the one or more graphics processing hardware units of the first plurality of graphics processing hardware units that are used in performing the 2D graphics operation.

21. The apparatus of claim 19, further comprising:
means for saving context information associated with the 3D graphics processing in accordance with the 3D graphics pipeline;
means for switching a context to perform the 2D graphics operation; and
means for, subsequent to performing the 2D graphics operation, switching the context to resume performance of the 3D graphical processing based at least in part on the saved context information.

22. The apparatus of claim 19, wherein:
the means for performing the 2D graphics operation includes means for performing a clear operation to write a default value to a destination location; and
wherein the second plurality of graphics processing hardware units comprises a level 1 cache.

23. The apparatus of claim 19, wherein:
the means for performing the 2D graphics operation includes means for performing a bit block transfer operation to transfer a block of pixels from a source location to a destination location; and
the second plurality of graphics processing hardware units comprises a level 1 cache.

24. The apparatus of claim 19, wherein:
the means for performing the 2D graphics operation includes means for performing a bit block transfer with blending operation to blend a first block of pixels from a source location with a destination block of pixels at a destination location;
the second plurality of graphics processing hardware units comprises a level 1 cache; and
the one or more graphics processing hardware units of the first plurality of graphics processing hardware units comprises a color processor.

25. The apparatus of claim 19, wherein:
the means for performing the 2D graphics operation includes means for performing a format conversion of a block of pixels from a first color format to a second color format and means for performing a bit block transfer operation to transfer the format converted block of pixels to a destination location;
the second plurality of graphics processing hardware units comprises a level 1 cache; and
the one or more graphics processing hardware units of the first plurality of graphics processing hardware units comprises a color processor.

26. The apparatus of claim 19, wherein:
the means for the 2D graphics operation includes means for performing a scaling operation to scale a block of pixels and means for performing a bit block transfer operation to transfer the scaled block of pixels to a destination location;
the second plurality of graphics processing hardware units comprises a level 1 cache; and
the one or more graphics processing hardware units of the first plurality of graphics processing hardware units comprises a color processor and a texture processor.

27. A graphics processing unit (GPU) comprising:
a first plurality of graphics processing hardware units and a second plurality of graphics processing hardware units, wherein the GPU is configured to perform three-dimensional (3D) graphics processing in accordance with a 3D graphics pipeline using the first plurality of graphics processing hardware units of the GPU, and wherein the GPU is further configured to perform a two-dimensional (2D) graphics operation using the second plurality of graphics processing hardware units of the GPU and one or more graphics processing hardware units of the first plurality of graphics processing hardware units.

28. The GPU of claim 27, wherein the GPU is further configured to:
power down portions of the first plurality of graphics processing hardware units that are not used to perform the 2D graphics operation.

29. The GPU of claim 28, wherein power down portions of the first plurality of graphics processing hardware units that are not used to perform the 2D graphics operation further comprises:
power down one or more shader processors.

30. The GPU of claim 27, wherein the GPU is further configured to:
clock gate portions of the first plurality of graphics processing hardware units that are not used to perform the 2D graphics operation.
